(19) United States
(12) Patent Application Publication
(10) Pub. No.: US 2011/0148197 A1
(43) Pub. Date: Jun. 23, 2011

(54) IN-LINE UNINTERRUPTIBLE POWER SUPPLY

(76) Inventors: Maurilio Hernandez, Chicago, IL (US); Wei Liang, Guangzhou (CN)

(21) Appl. No.: 12/943,682

(22) Filed: Nov. 10, 2010

Related U.S. Application Data
(63) Continuation-in-part of application No. 12/653,978, filed on Dec. 21, 2009.
(60) Provisional application No. 61/314,547, filed on Mar. 16, 2010.

(51) Int. Cl. H02J 3/06; G06F 13/14

(52) U.S. Cl. 307/26; 710/303

(57) ABSTRACT

A portable power station and/or an in-line uninterruptible power supply for use with a laptop, mobile computer, netbook, notebook and other electronic devices is presented. The in-line uninterruptible power supply comprises a plurality of data ports disposed in a communicative relation with the electronic device and a plurality of power output ports for simultaneously providing power to a plurality of various electronic devices. In addition, at least one embodiment of the in-line uninterruptible power supply station is positioned between at least one of the electronic device's power adapter and the corresponding base unit, and is structured to supply continuous power to the connected electronic device(s), even in the event of a temporary power failure.

### CLAIM OF PRIORITY

The present application is a continuation-in-part application of previously filed, now pending patent application having Ser. No. 12/653,978, filed on Dec. 21, 2009, and is also based on and a claim to priority is made under 35 U.S.C. Section 119(e) to a provisional patent application currently pending in the U.S. Patent and Trademark Office, having Ser. No. 61/314,547 and a filing date of Mar. 16, 2010, each of which are incorporated herein in their entirety by reference.

### BACKGROUND OF THE INVENTION

1. Field of the Invention

The present invention is generally directed to an in-line uninterruptible power supply for use with an electronic device having a base unit and a removable power adapter. In particular, the in-line uninterruptible power supply of the various embodiments of the present invention is cooperatively positioned between the removable power adapter and the base unit of the electronic device, which provides numerous advantages and benefits as discussed in greater detail hereinafter, and is structured and configured to supply continuous power to the electronic device, even in the event of a temporary power failure.

2. Description of the Related Art

Many individuals and companies utilize an uninterruptible power supply (“UPS”) or battery back-up for their personal computers, television sets, entertainment systems, and other modern day, and generally expensive or essential electronic devices. These UPS devices generally plug into or are otherwise directly connected to a power source such as a wall outlet and are structured to accept or receive AC power therefrom, convert the AC power to DC power, store the DC power in a battery, and re-convert the DC power from the battery back to AC power, which is then supplied or routed as an output from the UPS. This AC power is then utilized to power or run attached electronic devices.

Accordingly, in a typical UPS application, the user will install a UPS between the wall outlet or other power source and the power cable or power adapter of the electronic device. The UPS is generally structured to provide back up power to the electronic device and/or surge protection in the event of a power failure, power surge, etc. In particular, there are a plurality of common UPS designs and applications, such as, for example, on-line, double-conversion, line-interactive, offline/standby, hybrid topology or double conversion on demand, ferro-resonant, and rotary UPS systems, each of which comprise several unique advantages and disadvantages.

Such UPS devices are costly, bulky, heavy, and unnecessarily inefficient due to the way the power is received, converted, stored, and re-converted, as described above. The multiple AC-DC and DC-AC conversions create a significant amount of heat and waste a significant amount of power and energy.

Moreover, many electronic devices, including, but in no way limited to, cable and DSL modems, routers, switches, security systems, cameras, telephones, switch boards, etc., comprise a power adapter or transformer that is structured to receive AC power, for example, from a wall outlet, convert that AC power to DC, and provide the appropriate signal to the electronic device for operation. When these devices are connected to a typical UPS which comprises its own AC-DC and DC-AC converters, the amount of hardware, conversions, and loss of power becomes rather excessive. There is thus a need for an in-line uninterruptible power supply positioned and disposed between the power adapter and the base unit of the electronic device, rather than between the wall outlet and the power adapter, and which is structured to provide continuous power and/or surge protection to the electronic device even in the event of a power failure, brownout, blackout, power surge, microvoltage cuts or interruptions, etc.

### SUMMARY OF THE INVENTION

The present invention is generally directed to an in-line uninterruptible power supply for use with an electronic device, wherein the electronic device comprises a base unit and a power adapter. Specifically, the in-line uninterruptible power supply of the various embodiments of the present invention is cooperatively positioned and disposed between the power adapter and the base unit of the electronic device, and is further structured and configured to supply continuous power to the electronic device, even in the event of a temporary power failure. Specifically, the in-line UPS of the present invention uses the power adapter that comes with or is supplied by the electronic device that the user wishes to power. In at least one embodiment, the input and output of the in-line UPS device comprises DC power, eliminating extraneous AC-DC and DC-AC conversions, resulting in a significantly reduced cost, weight, and power loss, and further allowing the in-line UPS to power the electronic device for more than three times longer than traditional UPS devices with comparable or the same battery reserve power.

In particular, the various embodiments of the present invention comprise a housing, an input, an output, and a chargeable and/or rechargeable battery device, wherein the input and output are accessible from a position external to the housing. Moreover, the input of the in-line UPS of the present invention is structured to connect, either directly or indirectly (via a connecting adapter or tip), to a first end of the power adapter of the electronic device, the opposing second end of the power adapter being connected to a power source, such as a wall outlet. The output of the in-line UPS is structured to connect, either directly or indirectly (via a connecting adapter or tip), to the base unit of the electronic device, and in particular, to the jack or input designed for the power adapter, and supply continuous power thereto.

Accordingly, although most power sources and wall outlets supply AC power, the signal coming from or otherwise carried by the power adapter of the electronic device, in many applications, is DC power, as the power adapter, in many applications, comprises an AC-DC converter or transformer. Thus, in such an instance, the in-line UPS of the present invention need not comprise an input AC-DC converter. Oftentimes, however, the input signal or voltage coming from the power adapter may need to be raised or lowered so as to correspond with a predetermined battery input signal. Thus, in at least one embodiment the input of the in-line UPS is connected to an input signal converter, which is in turn connected to the internal rechargeable battery device. Therefore, the input signal (which in many instances is already in DC due to the power adapter hardware) may need to be “up-converted” or “down-converted” so as to correspond with a signal or voltage required to charge the battery device. The input signal converter in at least one embodiment is accomplished using an ultra high frequency range with small transformers, and thus maximizes efficiency with little to no power loss, relatively low heat, and minimal weight. In addition, less than 10% of the reserve power in the battery device is expelled as heat.

In addition, the in-line UPS device of the present invention may comprise an output signal converter connected to the rechargeable battery device and the in-line UPS output. In particular, the rechargeable battery device emits or discharges DC power which may need to be “up-converted” or “down-converter” so as to correspond with the input signal, or to otherwise properly power the electronic device for operation.

Certain electronic devices utilize AC power rather than DC power, and thus the power adapter associated with the particular electronic device may not convert the AC power from the power source to DC power, as explained above. In such an embodiment, the in-line UPS may direct the AC power at the input directly to the output and to the electronic device, at least partially bypassing the rechargeable battery device. In yet another embodiment, however, the in-line UPS may comprise an input AC-DC converter, and similarly, an output DC-AC converter. As the power adapter associated with the particular electronic device may generally convert the AC power source to a rather low voltage prior to reaching the input of the present invention, the input AC-DC converter, as well as the output DC-AC converter uses or otherwise comprises low voltage thereby minimizing the excessive power loss, heat generation, etc., associated with typical UPS units.

In addition, at least one embodiment of the in-line UPS of the present invention is structured and configured to accommodate or otherwise connect to a plurality of different electronic devices, each of which may comprise a unique connector, and require a unique signal or voltage to operate. Thus, the in-line UPS of at least one embodiment of the present invention is capable of accepting a range of inputs or input voltages, such as, for example, between 3 VDC and 48 VDC. The in-line UPS of at least one embodiment comprises appropriate hardware, circuitry, and devices, such as an input signal sensor to detect the input signal or voltage and automatically adjust the output signal to match. In yet another embodiment, however, the present invention comprises a manual signal or voltage selector accessible from a position external to the housing allowing the user to selectably control the output signal or voltage. It is also contemplated that the in-line UPS of the present invention is designed, customized, or configured to be operable with or otherwise accept an input from a specific predetermined signal or voltage.

Additional structural and operative variations of the present invention include a portable power station and/or an in-line uninterruptible power supply comprising a plurality of data ports capable of being disposed in a communicative relation with a laptop or other electronic device. The in-line uninterruptible power supply may further comprise a generally flat planar configuration with one or more ventilation channels for disposition of the laptop or electronic device in a confronting relation thereto. Furthermore, at least one embodiment comprises a plurality of power output ports configured to simultaneously provide power to a plurality of connected electronic devices.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of at least one embodiment of the in-line UPS disclosed in accordance with the present invention.

FIG. 1A is a schematic representation of an input connector adapter operatively disposed in accordance with at least one embodiment of the present invention.

FIG. 1B is a schematic representation of an output connector adapter operatively disposed in accordance with at least one embodiment of the present invention.

FIG. 2 is a rear elevation view of at least one embodiment of the in-line UPS disclosed in accordance with the present invention.

FIG. 2A is a front elevation view of the embodiment of the in-line UPS illustrated in FIG. 3.

FIG. 2B is a side elevation view of the embodiment of the in-line UPS illustrated in FIGS. 2 and 2A.

FIG. 3 is an illustrative and operative example of the in-line UPS disclosed in accordance with the present invention.

FIG. 4 is a schematic representation of at least one embodiment of the in-line UPS disclosed in accordance with the present invention.

FIG. 5 is a schematic representation of another embodiment of the in-line UPS of the present invention.

FIG. 6 is a schematic representation of yet another embodiment of the in-line UPS of the present invention.

FIG. 7 is a high level flow chart illustrating at least one embodiment of the method for providing an in-line UPS as disclosed herein.

FIG. 8 is a perspective view of another embodiment of the in-line uninterruptible power supply as disclosed herein.

FIG. 9 is a bottom view of the in-line uninterruptible power supply illustrated in FIG. 8.

FIG. 10 is a perspective view of a rechargeable battery device as disclosed in accordance with at least one embodiment of the present invention.

FIG. 11 is a rear elevation view of the in-line uninterruptible power supply illustrated in FIGS. 8 and 9.

FIG. 12 is a partial side elevation view of the in-line uninterruptible power supply as illustrated in FIGS. 8, 9 and 11.

FIG. 13 is a schematic design representation of yet another embodiment of the in-line uninterruptible power supply as disclosed herein.

Like reference numerals refer to like parts throughout the several views of the drawings.

### DETAILED DESCRIPTION OF THE PREFERRED EMBODIMENT

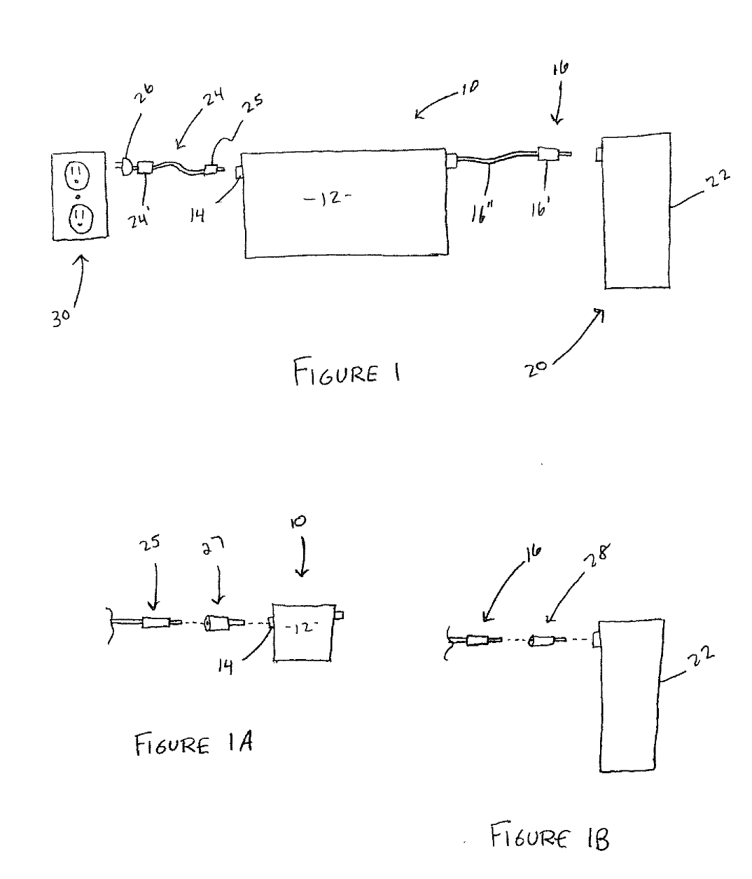

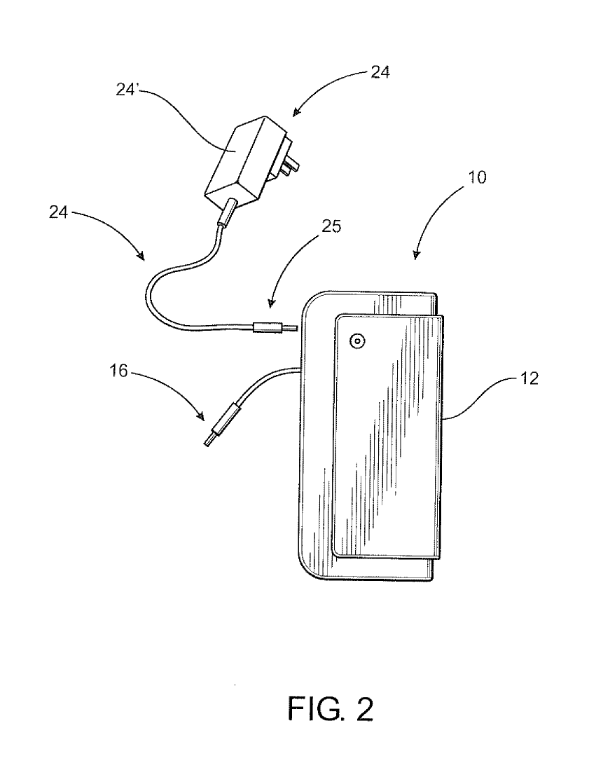

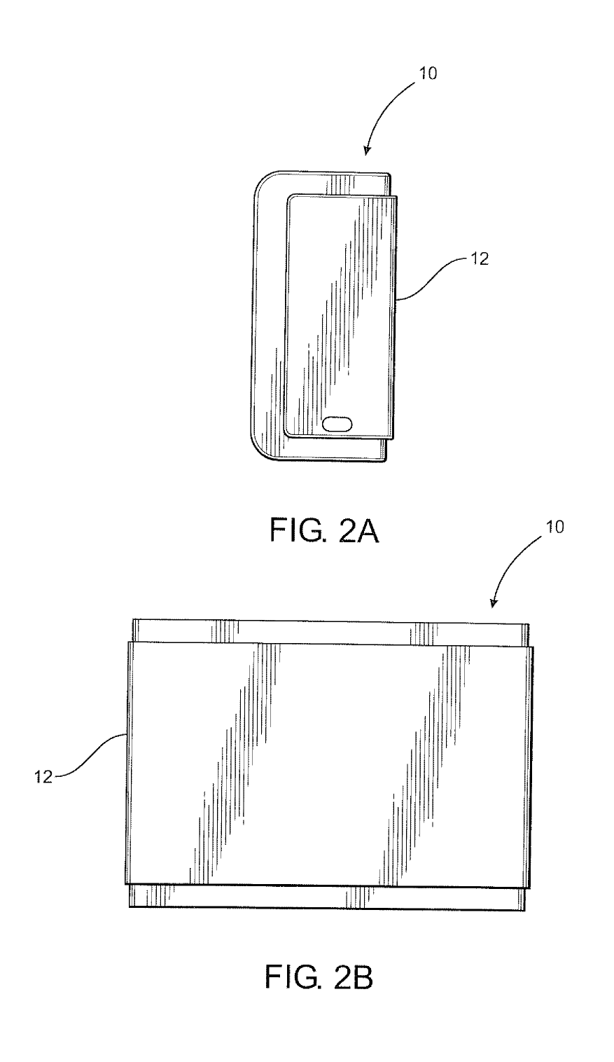

As shown in the accompanying figures, and with particular reference to FIGS. 1-3, the present invention is directed to an in-line uninterruptible power supply, generally referenced as 10, for use with an electronic device 20, wherein the electronic device 20 includes a base unit 22 and a power adapter 24. In particular, the in-line uninterruptible power supply 10 of the various embodiments of the present invention is cooperatively structured and configured to be disposed, positioned, and/or otherwise connected between the power adapter 24 and the base unit 22 of the electronic device 20.

For instance, many electronic devices 20, including, but certainly not limited to cable and DSL modems, routers, switches, desktop computers, laptop or mobile computers, printers, telephones, switch boards, security systems, cameras, etc., include a removable power adapter 24 or transformer that is structured to receive alternating current (“AC”) from a power source 30, such as a wall socket, convert the AC to direct current (“DC”), and provide the appropriate signal or voltage to the peripheral or base unit 22 for operation.

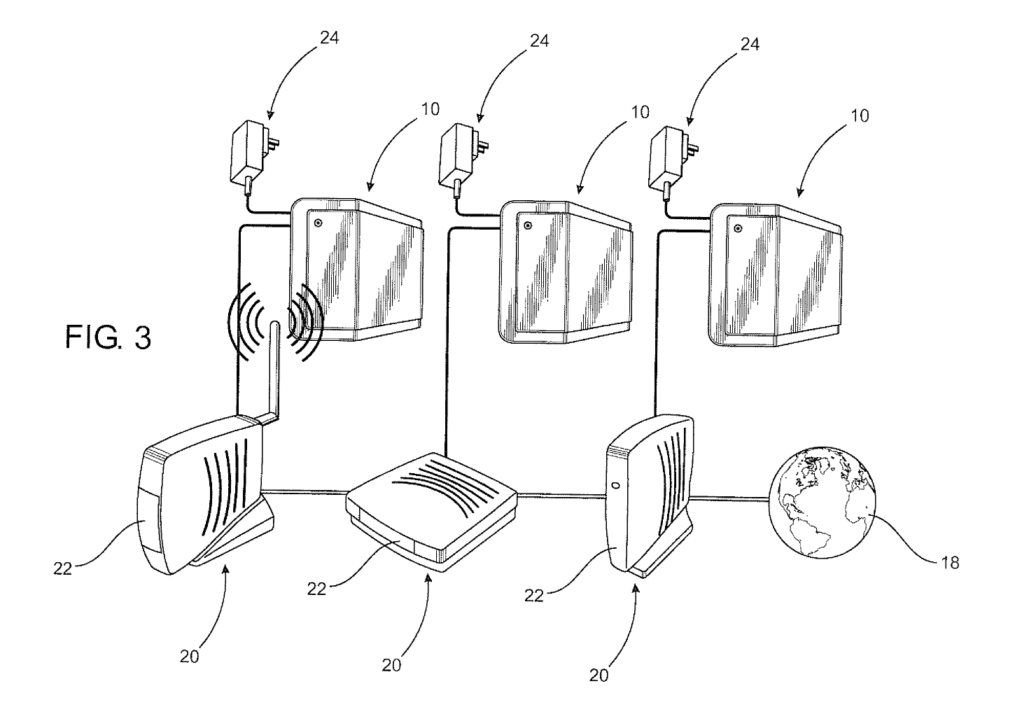

For instance, and referring now to an exemplary and illustrative embodiment and installation of the present invention shown in FIG. 3, the in-line uninterruptible power supply 10 of the various embodiments may be used with any of a plurality of electronic devices 20, such as a wireless router, switch, and/or high-speed internet modem, which are in turn connected to the Internet 18. Thus, in the event of a power failure, brownout, blackout, or other power malfunction, the in-line uninterruptible power supply 10 of the present invention will, for a period of time, continuously supply power to the device(s) 20, e.g., the Internet devices shown in FIG. 3, and maintain a connection with the Internet 18. This will, in turn, allow businesses to maintain a high level of worker productivity, which in many instances is dependent upon a continuous and reliable connection to the Internet, even during a temporary brownout, blackout, or power failure or malfunction. Of course the various embodiments of the present invention may be used in connection with a plurality of electronic devices 20, including, but certainly not limited to cable and DSL modems, routers, switches, desktop computers, laptop or mobile computers, printers, telephones, switch boards, security systems, cameras, solar panel and wind generators, charging control systems for solar panels and wind generators, etc.

Moreover, as mentioned above, the in-line uninterruptible power supply 10, or in-line UPS 10, of the various embodiments of the present invention is structured to be disposed and connected between the electronic device's 20 power adapter 24 and the base unit 20. Such a configuration eliminates the need for extraneous and high-voltage AC-DC and DC-AC conversions, eliminates unnecessary power loss, weight, and bulkiness, and allows the UPS to power the electronic device(s) 20 for a significant amount of time longer than traditional back-end UPS devices.

In particular, and referring now to FIG. 1, the various embodiments of the present invention comprise a casing or housing 12, at least one input 14, and at least one output 16. The input 14 is accessible from a position external to the housing 12 and is configured and structured to connect to or otherwise couple with a first end 25 of the power adapter 24 associated with the electronic device 20. In particular, the first end 25 of the power adapter 24 is typically connected directly to the base unit 22 of the electronic device 20 for applications not comprising the use of the in-line UPS 10 of the present invention. The first end 25, which comprises a power plug or connector, may be removed or disconnected from the base unit 22 and connected, either directly or indirectly (via an input connector adapter 27), to the input 14 of the in-line UPS device of the present invention.

In at least one embodiment, the input 14 comprises a female socket cooperatively structured to connect to the power connector located at the first end 25 of the power adapter 24. Further, in the event the connector located at the first end 25 of the power adapter 24 does not fit or couple with the input 14 directly, then at least one embodiment of the present invention further comprises at least one input connector adapter 27 cooperatively configured to connect or couple with both the first end 25 of the power adapter 24 and the input 14, as schematically illustrated in FIG. 1A.

Still referring to FIG. 1, the power adapter 24 comprises a second end 26 connected to a power source 30, such as, for instance a wall socket, electrical outlet, or electric plug. In most cases, the power source 30 supplies AC power to the power adapter 24. The power adapter 24 may then include a conversion device 24′ which may comprise an AC-DC converter, AC-AC converter, or other proper circuitry, device(s), or converters appropriate for the corresponding base unit 22 to operate. Accordingly, depending upon the particular device 20, the signal, such as the voltage, power, and/or current at the input 14 may vary and be either AC or DC.

Furthermore, as illustrated in FIG. 1, the various embodiments of the in-line UPS 10 of the present invention comprise an output 16 accessible from a position external to the housing 12 and structured and configured to be disposed in a direct or indirect connecting relation to the base unit 22 of the electronic device 20. As illustrated in FIG. 1, the output 16 of at least one embodiment may comprise a power connector 16′ disposed at the end of a cable 16″, however, other configurations structured to facilitate the operation of the present invention in the intended manner are contemplated. In particular, the output 16 and/or power connector 16′ thereof is, in at least one embodiment, coupled to the input from which the power adapter 24 was removed or disconnected, as described above. Furthermore, at least one embodiment comprises an output connector adapter 28 cooperatively configured to connect or couple with both the output 16 or power connector 16′ thereof and an input of the base unit 22, as schematically illustrated in FIG. 1B.

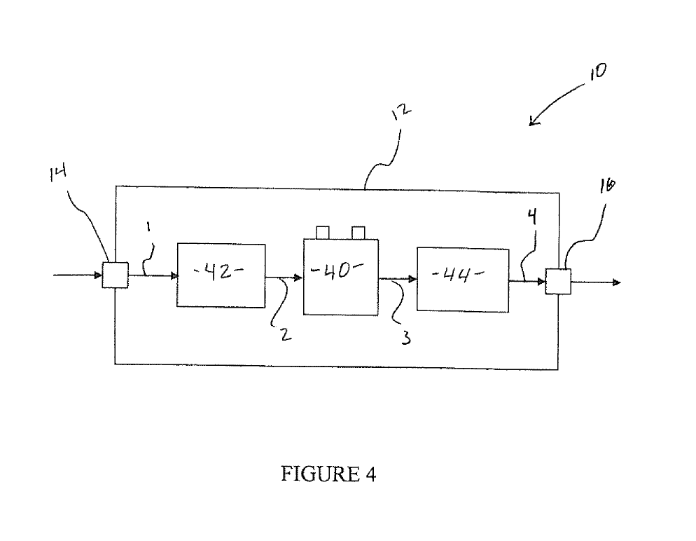

Referring now to FIG. 4, the various embodiments of the present invention comprise a rechargeable battery device 40 disposed within the housing 12 and in a direct or indirect communicative relation with the input 14 and output 16. The rechargeable battery device 40 of the various embodiments comprises virtually any type of battery structured to receive, store, and output a charge or power, including, but certainly not limited to an internal lead acid battery. Moreover, the rechargeable battery device 40 is structured to receive a battery input signal or voltage, as generally and schematically referenced at 2, which in turn is structured to charge the battery device 40. Similarly, the battery device 40 is structured to emit or discharge a battery output signal or voltage, generally and schematically referenced at 3.

Further, because the voltage level or battery input signal 2 required to charge the rechargeable battery device 40 may be different from the voltage level, current or signal provided by the power adapter 24 of the electronic device 20, such as a UPS input signal or first source, generally and schematically referenced at 1, at least one embodiment of the present invention further comprises an input signal converter 42. The input signal converter 42 is disposed in a communicative or connected relation with the input 14 and the rechargeable battery device 40, and is cooperatively structured to convert the first source or UPS input signal 1 to the appropriate battery input signal or voltage 2 operative to charge the battery device 40. In particular, because the input signal 1 of at least one embodiment comprises DC power, and because the rechargeable battery device 40 of at least one embodiment requires DC power to charge, the input signal converter 42 of such an embodiment comprises a DC to DC voltage converter structured to raise and/or lower the voltage as needed.

Moreover, at least one embodiment of the in-line UPS 10 is configured and structured to connect with or adapt to a plurality of different electronic devices 20, and thus, the input 14 is structured to accept a range of input voltages. For exemplary purposes only, the voltage supplied by the power adapter 24 of the particular electronic device 20 may be anywhere within a wide range of input voltages, such as, 3 VDC to 48 VDC, whereas the battery device 40 may require a particular predefined input signal or voltage, such as, a 6 VDV input. Thus, if, for example, the UPS input signal 1 is equal to 3 VDC, and the battery device 40 requires a 6 VDC input, then the input signal converter 42 of at least one embodiment is structured to “up-convert” the UPS input signal or voltage 1 to the required battery input signal or voltage 2. Also, if, for example, the UPS input signal 1 of one application of the present invention is equal to 48 VDC, and the battery device 40 again requires a 6 VDC input, then the input signal converter 42 is structured to “down-convert” the UPS input signal 1 to the required battery input signal 2. Of course, the above voltages and voltage ranges are merely presented for exemplary purposes only, and the present invention is in no way limited to such.

In addition, at least one embodiment of the present invention comprises an input signal or voltage sensor 43 disposed in a communicative and signal-reading relation with the input 14 and/or the input signal converter 42. In particular, the input signal sensor 43 comprises appropriate circuitry and/or microprocessor(s) structured to detect and measure the signal, such as the voltage and/or current levels, at the input 14. Thus, at least one embodiment of the present invention is structured to receive a range of input signals or input voltages, detect the input signal via the input signal sensor 43, and convert the input signal or voltage as necessary.

Furthermore, and still referring to FIG. 4, at least one embodiment of the present invention comprises an output signal converter 44 disposed in a communicative relation with the rechargeable battery device 40 and the output 16. In particular, the output signal converter 44 comprises appropriate circuitry, logic, and devices structured to convert a battery output signal or voltage 3 to, for example, a UPS output signal 4 located at the output 16. In particular, because the base unit 22 of the electronic device 20 is structured to accepts the signal coming from its own power adapter 24 (which is connected to the UPS input 14), in at least one embodiment, the present invention comprises appropriate circuitry, logic or devices to ensure that the UPS input signal 1 is equivalent or substantially equivalent to the UPS output signal 4. Furthermore, because the battery output signal 3 of at least one embodiment comprises DC power, and because the UPS input signal 1 (and thus the UPS output signal 4) of at least one embodiment comprises DC power, the output signal converter 44 of such an embodiment comprises a DC to DC voltage converter structured to raise or lower the voltage as needed. Accordingly, the battery output signal 3 may, in some instances, need to be “up-converted” or “down-converted” so as to appropriately raise or lower the voltage, respectively.

For instance, in at least one embodiment, the present invention comprises an output signal controller 46 disposed in a communicative relation with, and being structure to at least partially control, the output signal converter 44. The output signal controller 46 is further disposed in a communicative relation with the input signal sensor 43 in that the output signal converter 46 is structured to receive information or data relating to the input signal 1, such as its voltage, current, etc., and control or otherwise communicate this information to the output signal converter 44. The output signal converter 44 can then appropriately convert the battery output signal 3 if necessary so as to be equivalent or substantially equivalent to the input signal 1.

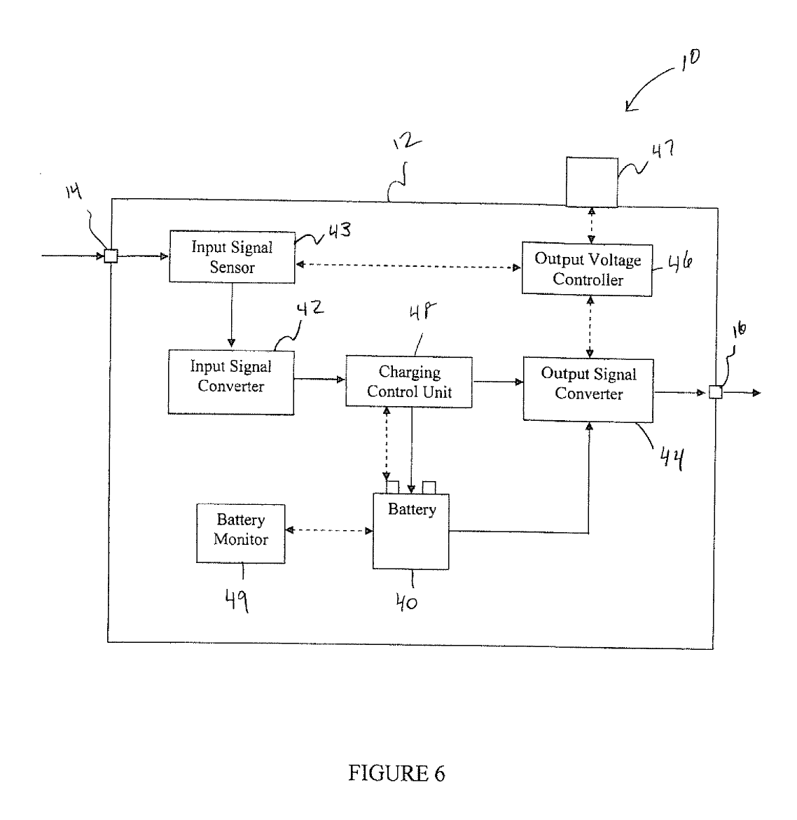

In yet another embodiment, and as shown in FIG. 6, the output signal controller 46 is disposed in a communicative relation with a signal or voltage selector 47. In particular, the voltage selector 47 is at least partially externally accessible such that a user or other individual may manually and/or selectively adjust the output voltage or output signal 4 for the in-line UPS 10 of the present invention. Thus, rather than automatically detecting the input signal and communicating the same to the output signal converter 44, as discussed above, at least one embodiment is structured to allow a user to manually and selectively adjust the output signal 4 or voltage. Accordingly, the voltage or signal selector 47 may comprise a sliding, rotating, or other adjustable or selectable switch, notch, potentiometer, etc.

Furthermore, as identified above, the input signal 1 from the power adapter 24 may comprise AC or DC. In at least one embodiment, if the input signal sensor 43 or other circuitry detects that the input is AC, the AC source will bypass the various components described above, and will be directed to the output 16 and into the base unit 22 of the electronic device 20. It is also contemplated however, that in at least one embodiment, an input AC-DC converter and output DC-AC converter is included in the in-line UPS 10 of the present invention so as to allow the rechargeable battery device 40 to charge and thus the in-line UPS 10 of at least one embodiment may be structured to accommodate and be operable with devices that operate by or otherwise receive AC signal(s). In particular, the AC-DC and DC-AC converters may but need not comprise a set of diodes or other hardware structured to appropriately convert the signal. Additionally, the power adapter of the electronic device 20 generally converts the AC input signal to a low voltage, and as such, the AC-DC and/or DC-AC converter(s) of at least one embodiment utilizes or otherwise operates at a low voltage thereby minimizing power loss and heat generation.

In addition, the present invention may also include a charging control unit 48 disposed in a communicative relation with the rechargeable battery device 40. In particular, the charging control unit 48 comprises appropriate circuitry and logic to manage the charging of and/or regulate power to the rechargeable battery device 40. For instance, the charging control unit 48 of at least one embodiment is structured to detect the battery level of the battery device 40, and if it is below a certain level or otherwise not charged to its maximum potential, the charging unit 48 is structured to direct the input signal 1 to the battery 40 and/or to the input signal converter 42. If the charging control unit 48 detects that the battery device 40 is fully charged, then in at least one embodiment, the charging control unit 48 is structured to direct the input signal 1 directly to the output 16. In the event of a power failure, brownout, blackout, microvoltage cut or interruption, etc., the in-line UPS 10 is structured to continuously supply power from the battery device 40 as described above.

In addition, and for exemplary purposes only, certain power adapters 24 configured for use with an electronic device 20 are designed or implemented with excess capacity structured to handle the maximum load anticipated by the attached device 20. In many cases, this excess capacity is designed as a safety feature from the original manufacturer. For instance, many peripherals and devices 20 draw or consume more power at start-up or when the device 20 is initially powered on than when the device has been running for some time and has reached a steady state. This extraneous or excess capacity can be used, for instance by the charging control unit 48 of at least one embodiment of the present invention to charge the rechargeable battery device 40 that may later provide power to the device 20 upon the occurrence of a brownout, blackout, or other power failure or malfunction. For instance, the input signal, whether it be AC or DC, may be split, divided, allocated or otherwise utilized in a manner such that at least a portion of the excess power capacity is routed so as to charge the battery, while the remaining power is concurrently used or routed to operate the electronic device. Of course the input signal or portions of the input signal may, depending upon the particular application, need to pass though an input signal converter, for instance, so as to “up-convert,” “down-convert,” or convert to/from AC-DC as necessary and as discussed in detail above.

Further, at least one embodiment of the present invention comprises a battery monitor device 49 disposed in a communicative and monitoring relation with the rechargeable battery device 40. In particular, the battery monitor device 49 comprises appropriate circuitry, logic, and devices structured to monitor the battery level of the rechargeable battery device 40 and emit one or more signals, for instance audible and visual warnings, at a predetermined or preprogrammed moment, such as ten (10) minutes prior to the rechargeable battery device 40 being completely depleted and power being disconnected to the electronic device 20.

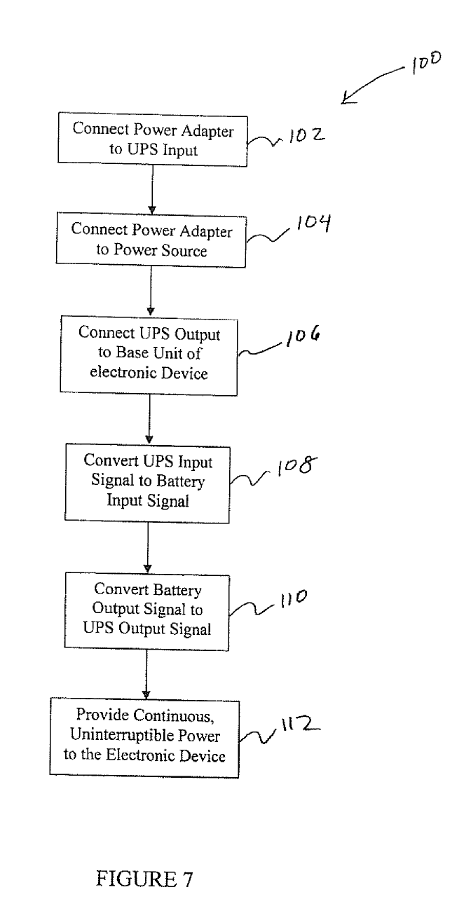

Additionally and as generally represented in the high level flow chart of FIG. 7, the present invention further comprises a method for providing an in-line uninterruptible power supply 100 to the electronic device. In particular, the method 100 of at least one embodiment comprises providing a UPS input for connecting the first end of the power adapter thereto 102, connecting the second end of the power adapter to the power source such as a wall outlet 104, and providing a UPS output for connecting to the base unit of the electronic device 106. Of course, as described above, the first end of the power adapter may connect either directly to the UPS input, or indirectly via the use of an input connector adapter. Similarly, the UPS output may connect directly to the base unit or indirectly via an output connector adapter.

The method 100 further comprises converting a UPS input signal from the power adapter to a predetermined battery input signal 108, for instance, via a DC to DC input signal converter. Specifically, the battery input signal is structured to charge the rechargeable battery device of the in-line UPS and in at least one embodiment comprises a predetermined DC power or voltage. As the UPS input signal of at least one embodiment is also DC power (which is carried by the power adapter of the electronic device), the UPS input signal may need to be “up-converted” or “down-converted” as necessary to correspond with the predetermined battery input signal or voltage.

In addition, the method 100 of at least one embodiment comprises converting a battery output signal to a UPS output signal 110, for instance, via a DC to DC output signal converter. In particular, the battery output signal of at least one embodiment comprises DC power. In addition, the base unit of the electronic device of at least one embodiment is structured to run or operate via DC power. Thus, the battery output signal may, in some instances, need to be “up-converted” or “down-converted” to correspond to the appropriate signal or voltage level required to operate the base device.

Finally, the method 100 of the various embodiments of the present invention comprises providing continuous, uninterruptible power to the electronic device via the UPS output 110, even in the event of a power failure from the power source. Specifically, the method 100 and/or in-line UPS 10 of the various embodiments of the present invention may be configured in any of a number of manners so as to provide continuous power to the electronic device. In particular, there are a plurality of common UPS configurations, for example, on-line, double-conversion, line-interactive, off-line, hybrid, etc., some of which continuously supply power from the battery even during proper power source functionality, and others which may be structured to switch to the battery device only upon the occurrence of a power failure or malfunction. Accordingly, the method 100 and in-line UPS 10 of the present invention may operate in any of these manners cooperatively structured to implement the operative features of the present invention in the intended manner, as described in detail herein.

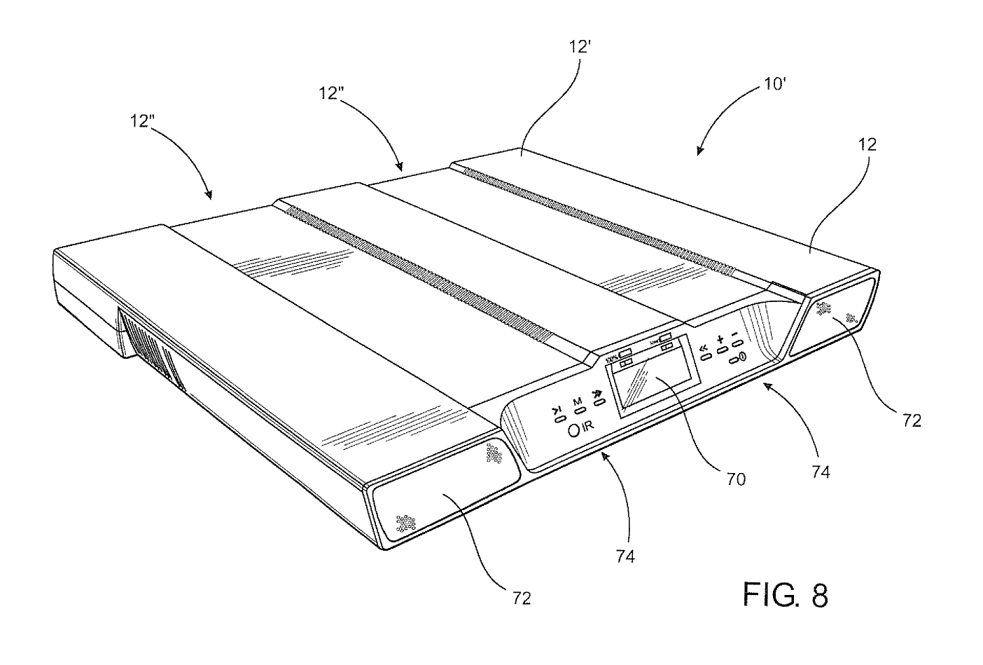

Referring now to FIGS. 8-13, certain structural and operative variations of the present invention are shown in the portable power station and/or in-line uninterruptible power supply (“UPS”) generally referenced as 10′. In particular, the housing 12 of at least one embodiment comprises a substantially flat, planar upper surface 12′ for disposition of an electronic device, including but certainly not limited to a laptop, mobile computer, netbook, etc., thereon. For instance, the bottom surface of the electronic device may be disposed in a confronting relation with the upper surface 12′ of the in-line UPS 10′ in a manner such that the electronic device rests or sits thereon. Accordingly, at least one embodiment of the in-line UPS 10′ of the present invention comprises an upper surface 12′ of a sufficiently flat and dimensional area to support or otherwise be disposed in a confronting relation with an electronic device 20 such as a laptop.

Further, the upper surface 12′ of the embodiment illustrated in FIG. 8 comprises one or more ventilation channels 12″, which in at least one embodiment extend or are otherwise disposed substantially or completely across a length or width of the upper surface 12′. The ventilation channels 12″ are structured to be open or otherwise provide an escape route for air on at least one end of the upper surface 12′, especially when a laptop or other electronic device 20 is disposed in an overlying or confronting relation thereto. More specifically, when a laptop or other electronic device is disposed in a confronting or overlying relation with the upper surface 12′, the ventilation channels 12″ are structured to define a space or channel in which warm or hot air generated by the electronic device and/or the in-line UPS 10′ can easily dissipate.

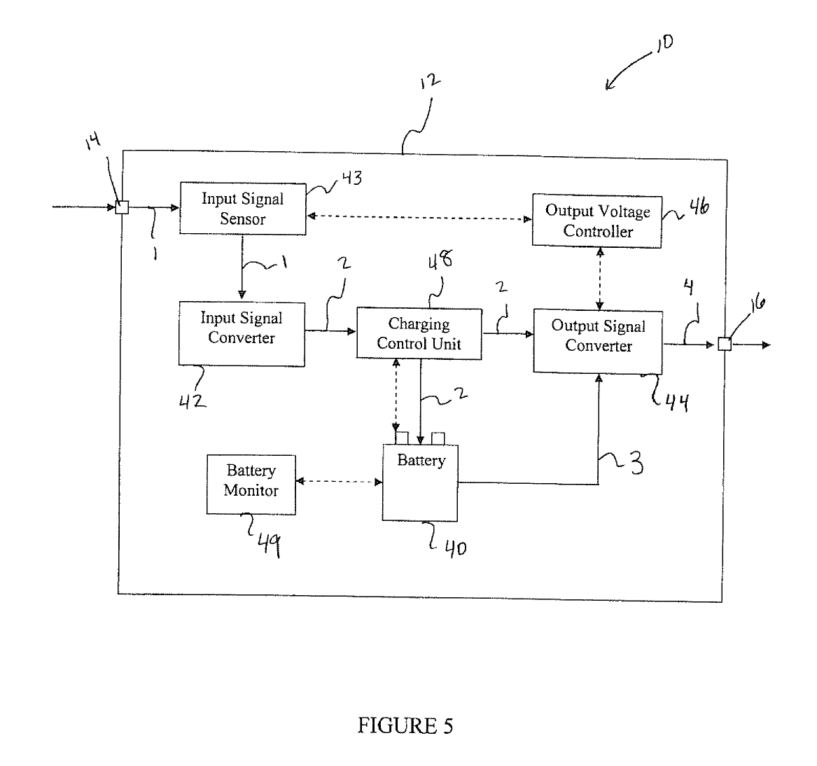

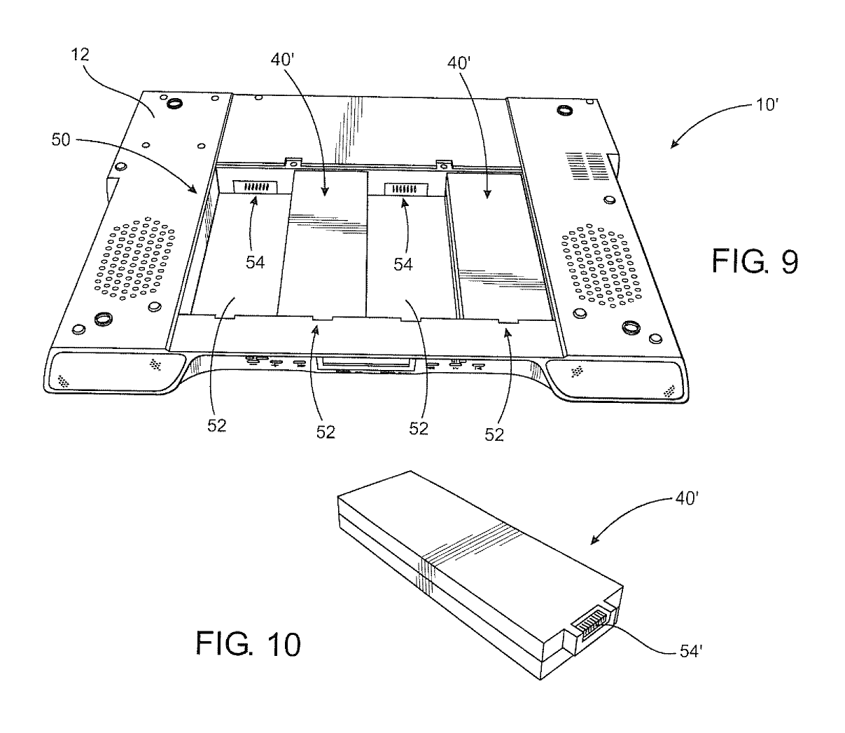

Referring now to the bottom view of the in-line UPS 10′ as represented in FIG. 9, the housing 12 of at least one embodiment comprises a battery bay 50 cooperatively structured to removably dispose one or more rechargeable battery devices 40′ therein. For exemplary purposes only, the embodiment illustrated in FIG. 9 comprises a battery bay 50 capable of disposing four (4) rechargeable battery devices 40′ therein. In particular, the battery bay 50 comprises a battery slot for a different one of each of the plurality of battery devices 40′. In at least one embodiment, each slot 52 and battery 40′ pair comprises cooperatively structured coupling devices 54, 54′ such as a plurality of cooperatively disposed prongs, contact points, and/or other structures capable of disposing the battery device 40′ in a powering or electrically communicative relation with the in-line UPS 10′ so as to facilitate the practice of the present invention in the intended manner. As described in detail above with reference to the embodiments shown in FIGS. 1 through 7, the battery device 40′ is structured to provide power to at least one corresponding and connected power output port, even in the event of a power disruption, power failure, etc. at the external power source.

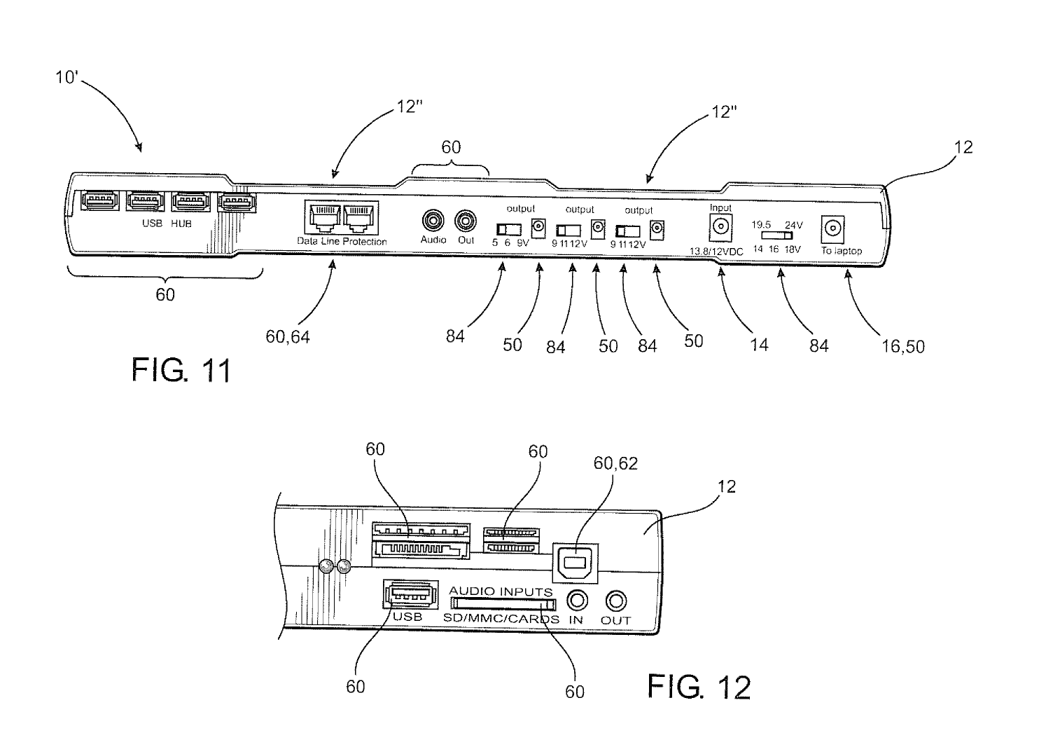

As illustrated in the rear view of FIG. 11, the in-line UPS 10′ comprises at least one power input port 14 and a plurality of power output ports 16, 50. In at least one embodiment, the power input port 14 is connected to a power adapter 24 associated with the electronic device 20, as described in greater detail above. Specifically, the power adapter 24 comprises an integrated or connected AC to DC signal converter such that an AC signal provided by the external power source 30 is converted to a DC signal by the power adapter 24, thereby passing a DC signal into the power input port 14 of the present invention and eliminating the need for an additional AC to DC converter as described in greater detail above.

At least one of the power output ports 16 is connected, either directly or indirectly (via an extension, additional plug(s), adapter(s), tip(s), etc.) to the laptop or other electronic device 20. As will be described below, the other power output ports 50 may be connected to, either directly or indirectly, and/or otherwise provide power to other electronic devices, including but not limited to networking devices such as a modem, router, networking hub, etc. The in-line UPS 10′ of at least one embodiment may further comprise additional ports structured to provide power to and/or charge other electronic devices such as mobile telephones, game consoles, personal digital assistants, etc.

Furthermore, the in-line UPS 10′ of at least one embodiment comprises a plurality of data ports 60, including but not limited to Universal Serial Bus (“USB”), FireWire, RCA, Digital Video Input (“DVI”), High Definition Multimedia Interface (“HDMI”) ports, Audio ports, Multimedia card (“MMC”) slots, Secure Digital (“SD”) or Secure Digital High Capacity (“SDHC”) slots, etc. Moreover, the electronic device 20, and in particular, the laptop, netbook, notebook, mobile computer, etc., may be disposed in a communicative relation with the in-line UPS 10′ via at least one of the data ports 60, such as, for example, a USB port 62. As such, some or all of the other various data ports 60 are capable of communicating data to and/or from the electronic device 20 in a manner so as to facilitate the practice of the present invention. For instance, disposition of an external device, such as, for example, an external hard drive, speakers, or a memory card in a communicative relation with one or more of the data ports 60 will, in at least one embodiment, serve to communicate with the electronic device cooperatively connected to the in-line UPS 10′ such as via data port 62. In addition, the in-line UPS 10′ is capable of providing surge protection and/or battery back-up support to one or more of the data ports 60, including an Ethernet port 64 or other data line port commonly provided to connect to the World Wide Web or other network or collection of networks.

Referring again to FIG. 8, at least one embodiment of the in-line UPS 10′ comprises a display panel 70, such as, for example a liquid crystal display (“LCD”) panel, capable of displaying various data and/or information corresponding to the available charge remaining in the battery device(s) 40′ and/or information or data obtained by or supplied from the laptop. For example, because the laptop or other electronic device 20 may be disposed in a communicative relation with the in-line UPS 10′ via on or more of the data ports 60, as described above, the display panel 70 may also be connected via various internal circuitry to the electronic device 20. In addition, the electronic device 20 may be playing or be capable of playing one or more multimedia files, including music or audio files, videos, animation, slideshows, etc. Accordingly, the various laptop data displayed on the display panel 70 of at least one embodiment may include, but is not limited to, volume level, audio track number currently playing, artist name, track title, album title, genre of music playing, etc.

Furthermore, in the embodiment illustrated in FIG. 8, the in-line UPS 10′ and in particular the housing 12 thereof, comprises one or a plurality of speakers 72 structured to emit sound or audio signals provided by the laptop or other electronic device 20. The speakers 72 are thus disposed in a communicative relation with the electronic device 20 via internal circuitry and/or one or more of the various data ports 60 described above. In addition, the in-line UPS 10′ may comprise a variety of multimedia controls 74 structured to at least partially control the multimedia signal provided by the electronic device 20. Accordingly, the multimedia controls 74 may adjust or control volume, track number, speed of playback, etc.

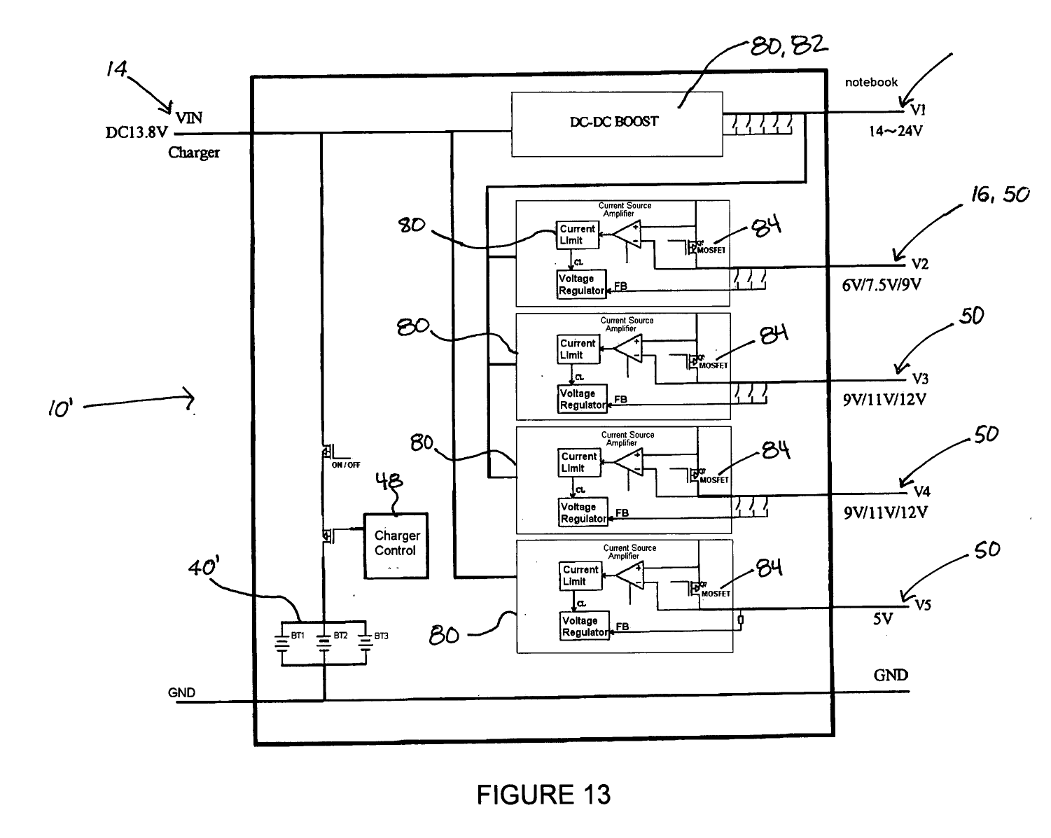

FIG. 13 is a schematic design representation of at least one embodiment of the in-line UPS 10′ of the present invention comprising one power input port 14 and five power output ports 50. In particular, as illustrated in FIG. 13, the present invention comprises a charging control unit 48 disposed in a communicative relation with the power input port 14 and the one or more rechargeable battery devices 40′. As described above, the charging control unit 48 is structured to control the charging of the battery devices 40′ and, in at least one embodiment, convert the power input signal at the power input port 14 to a predetermined battery input signal capable of at least partially charging the battery device(s) 40′. In particular, as described in detail above, this may include an “up convert” or a “down convert” depending upon the voltage of the input signal and the predefined or predetermined voltage required to charge the battery. Accordingly, because the input signal of at least one embodiment comprises a DC signal, the charging control unit 48 may comprises an appropriately configured DC to DC converter.

In addition, and still referring to FIG. 13, the present invention further comprises at least one signal converter disposed within the housing 12 and in a communicative relation with at least one of the plurality of power output ports 50. For instance, the signal converter 80 may, in at least one embodiment, comprise a DC to DC signal booster, as generally represented at 82, which is then connected to one power output port 16 and one or more other signal converters 80, as represented in FIG. 13. In particular, the embodiment represented in FIG. 13 comprises a plurality of signal converters 80, each connected to or otherwise outputting directly to a different one of the plurality of power output ports 50.

Moreover, the signal converters 80 may be disposed in a communicative relation with a selectable voltage controller 84. For example, as illustrated in FIG. 11, a selectable voltage controlled 84 is adjacent to a corresponding one of the power output ports 50 and is disposed in an externally accessible position relative to the housing. Of course, the selectable voltage controller 84 may be disposed elsewhere, and may, for example, be digitally embodied into the display panel 70. In any event, the selectable voltage controller 84 is structured to define a selectable voltage value associated with a corresponding one of the power output ports 50.

For exemplary purposes only, the embodiment illustrated in FIG. 11 comprises four power output ports 50, each of which comprises a corresponding selectable voltage controller 84 in the form of a sliding notch. Depending on which power output 50 is used, the voltage at the outputs may vary from 5 VDC to 9 VDC, 9 VDC to 12 VDC, and 14 VDC to 24 VDC. Of course, the embodiment illustrated is exemplary only and these voltage values and ranges should in no way be deemed limiting.

Furthermore, as illustrated in FIG. 13, the digital control system of the present invention, and in particular, the signal converters 80 comprise the use of transistors 84, such as MOSFET's, in order to adjust and/or control the voltages at the power output ports 50. The transistor, like any switch, consumes less current than a resistor-based system, and while a transistor is generally more costly than a resistor, transistors save valuable power. The transistor, acting as a switch, creates a rapid “on” and “off” sequence, thereby causing the current to become more uneven. To address the resulting unevenness, at least one embodiment of the present invention comprises one or more capacitors to smooth out the current. The capacitor consumes much less current than other known current-smoothing methods and devices. The current, in an effort to step down the various voltages, becomes more variable. The resulting system is about 97% efficient, even with the adjusting of the voltages as described above.

The intended application of the present invention is varied and diverse in that it is structured to simultaneously provide power to a plurality of devices, while also providing surge protection to various data ports 60 and lines, and battery back up support to the electronic device(s) 20 as well. The input and output voltage ranges are selectable and thus the invention may be used with a variety of devices. For exemplary purposes only, a laptop power adapter 24 generally receives 100-200 volts AC and converts the voltage to 12.0-24 VDC depending on the particular laptop. In addition, a modem generally draws 9-12 VDC, a wireless router generally draws 9-12 VDC, a monitor or television generally draws 9-12 VDC. The present invention could simultaneously provide power to each of these items using the selectable voltage controls. In addition, at least one embodiment provides an additional 5 VDC to run one or more of the various data ports 60 such as the USB hub and card readers. Other ports may be provided to charge or run mobile phones, PDA's, camcorders, digital cameras, security monitors, motion sensors, etc.

The in-line UPS 10′ of the present invention will provide for extended operation once the internal batteries of the laptop are depleted. In addition, the in-line UPS 10′ could be connected to DC power from a car for recharging the battery 40′ and/or for operation as described herein.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An in-line uninterruptible power supply for a laptop, comprising:
a housing,
said housing comprising a plurality of data ports, wherein at least one of said plurality of data ports is disposed in a communicative relation with the laptop,
a power input port connected in a powering relation with an external power source,
a plurality of power output ports, wherein at least one said plurality of power output ports is configured to be disposed in a connected and powering relation with the laptop,
at least one rechargeable battery device removably connected to said housing and disposed in a communicative relation with said power input port and at least one of said plurality of power output ports, said rechargeable battery device being capable of at least temporarily providing power to said at least one corresponding power output port.

2. The in-line uninterruptible power supply as recited in claim 1 wherein said housing comprises at least one display panel; said display panel capable of displaying data corresponding to a battery level of said at least one rechargeable battery device.

3. The in-line uninterruptible power supply as recited in claim 2 wherein said display panel is disposed in a communicative relation with laptop and capable of displaying a plurality of laptop data.

4. The in-line uninterruptible power supply as recited in claim 1 wherein said housing further comprises at least one speaker capable of emitting an audio signal from the laptop.

5. The in-line uninterruptible power supply as recited in claim 4 wherein said housing further comprises a plurality of multimedia controls capable of adjusting the audio signal from the laptop.

6. The in-line uninterruptible power supply as recited in claim 1 wherein said housing comprises a substantially flat upper surface for disposition of a bottom surface of the laptop in a confronting relation thereto.

7. The in-line uninterruptible power supply as recited in claim 6 wherein said upper surface of said housing comprises at least one air ventilation channel.

8. The in-line uninterruptible power supply as recited in claim 1 wherein said power input port is connected to a power adapter associated with the laptop; the power adapter comprising an integrated AC-DC signal converter, wherein a power input signal passing through said power input port comprises a DC signal.

9. The in-line uninterruptible power supply as recited in claim 8 further comprising a charging control unit disposed in a communicative relation with said power input port and said rechargeable battery device; said charging control unit being structured to convert the power input signal to a predetermined battery input signal capable of at least partially charging said rechargeable battery device.

10. The in-line uninterruptible power supply as recited in claim 9 wherein said charging control unit comprises a DC to DC converter.

11. The in-line uninterruptible power supply as recited in claim 9 further comprising at least one signal converter disposed within said housing and in a communicative relation with at least one of said plurality of power output ports.

12. The in-line uninterruptible power supply as recited in claim 11 wherein said at least one signal converter comprises a DC-DC voltage booster.

13. The in-line uninterruptible power supply as recited in claim 9 further comprising a plurality of signal converters each disposed in a communicative relation with a different one of said plurality of power output ports.

14. The in-line uninterruptible power supply as recited in claim 13 wherein at least one of said plurality of signal converters is disposed in a communicative relation with a selectable voltage controller.

15. The in-line uninterruptible power supply as recited in claim 14 wherein said selectable voltage controller is disposed in an externally accessible position relative to said housing and structured to define a selectable voltage value associated with a corresponding one of said plurality of power output ports.

16. An in-line uninterruptible power supply capable of delivering electrical power to a plurality of electronic devices, wherein at least one of the plurality of electronic devices comprises a power adapter with an integrated AC to DC signal converter, said in-line uninterruptible power supply comprising:
a housing,
a power input port connectable to the power adapter of the at least one electronic device wherein a power input signal passing through said power input port comprises a DC signal,
a plurality of power output ports each connectable in a powering relation to a different on of the plurality of electronic devices,
a plurality of rechargeable battery devices removably connected to said housing and disposed in a communicative relation with said power input port and at least one of said plurality of power output ports,
said plurality of rechargeable battery devices being capable of at least temporarily providing power to said at least one corresponding power output port, and
a charging control unit disposed in a communicative relation with said power input port and said plurality of rechargeable battery devices, the charging control unit comprising a DC to DC signal converter structured to convert the power input signal to a predetermined battery input signal capable of at least partially charging said plurality of rechargeable battery devices.

17. The in-line uninterruptible power supply as recited in claim 16 wherein said housing comprises a plurality of data ports; at least one of the plurality of data ports being disposable in a communicative relation with at least one of the plurality of electronic devices.

18. The in-line uninterruptible power supply as recited in claim 16 wherein said housing further comprises a substantially flat upper surface for disposition of at least one of the plurality of electronic devices in a confronting relation thereto.

19. The in-line uninterruptible power supply as recited in claim 18 wherein said upper surface of said housing comprises at least one air ventilation channel disposed thereon.

20. The in-line uninterruptible power supply as recited in claim 16 further comprising a plurality of signal converters disposed within said housing; each of said signal converters capable of converting an output signal associated with a different one of said plurality of power output ports.

21. The in-line uninterruptible power supply as recited in claim 20 wherein at least one of said plurality of signal converters is disposed in a communicative relation with a selectable voltage controller structured to define a selectable voltage value associated with a corresponding one of the plurality of power output ports.
